(19) United States
(12) Patent Application Publication
(10) Pub. No.: US 2006/0164858 A1
(43) Pub. Date: Jul. 27, 2006

(54) Backlight assembly and display apparatus having the same

(75) Inventors: Sang-Hoon Park, Yongin-si (KR); Yoon-Soo Kwon, Seoul (KR); Jung-Tae Kang, Suwon-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/336,548

(22) Filed: Jan. 20, 2006

(30) Foreign Application Priority Data
Jan. 21, 2005 (KR) 2005-5905

(51) Int. Cl. F21V 7/04; F21V 29/00

(52) U.S. Cl. 362/561; 362/559; 362/294; 362/373; 362/330

(57) ABSTRACT

A backlight assembly includes an optical member, a light source module, a light-mixing member and a container. The optical member has a plate-like shape. The light source module provides a color light to the optical member. The light-mixing member is arranged between the optical member and the light source module. The container includes a bottom surface having a recess that receives the light source module, and a sidewall extending from an edge of the bottom surface. The sidewall includes a first supporting portion supporting the optical member, and a second supporting portion supporting the light-mixing member.

### CROSS REFERENCE TO RELATED APPLICATION

This application claims priority to and the benefit of 35 USC § 119 to Korean Patent Application No. 10-2005-0005905, filed on Jan. 21, 2005, which is hereby incorporated by reference for all purposes as if fully set forth herein.

### BACKGROUND OF THE INVENTION

1. Field of the Invention

The present invention relates to a backlight assembly and a liquid crystal display apparatus having the backlight assembly. More particularly, the present invention relates to a backlight assembly having an improved image display quality and a reduced size, volume and weight, and a liquid crystal display apparatus having the backlight assembly.

2. Description of the Related Art

A display device displays an image in accordance with data processed by an information-processing device. The display device may include a cathode ray tube (CRT) type display device, a liquid crystal display (LCD) device, a plasma display panel (PDP), an electroluminescence display device, etc.

The LCD device displays an image by using liquid crystal of which liquid crystal molecules are rearranged when an electric field is applied to the liquid crystal. The LCD device may be a transmissive type LCD, a reflective type LCD, or a reflective-transmissive type LCD.

The LCD device includes a light source so that an image may be displayed in the dark. The light source may include a light-emitting diode (LED), a cold cathode fluorescent lamp (CCFL), a flat fluorescent lamp (FFL), etc.

A light emitted from the LED has a higher luminance than that of a light emitted from the CCFL or the FFL and consumes less power.

The luminance of the light emitted from the LED varies in accordance with a peripheral temperature of the LED. When the peripheral temperature of the LED increases, the luminance of the light emitted from the LED decreases and deteriorates an image display.

To rapidly dissipate heat generated from the LED, a bulky cooling member is provided to the conventional LED, which increases a weight, a volume and a size of the LCD device.

Also, to improve luminance uniformity of a light generated from the conventional LED, a diffusion plate is used in the conventional LCD device. Thus, a supporting member that supports the diffusion plate is provided with the conventional LCD device, which increases the weight, the volume and the size of the LCD device.

### SUMMARY OF THE INVENTION

The present invention provides a backlight assembly having a compact size and a light weight, and a display apparatus having the backlight assembly.

Additional features of the invention will be set forth in the description which follows, and in part will be apparent from the description, or may be learned by practice of the invention.

The present invention discloses a backlight assembly, including an optical member; a light source module providing color light to the optical member; a light-mixing member arranged between the optical member and the light source module; and a container including a bottom surface that has a receiving space that receives the light source module, and a sidewall having a first supporting portion extending from a peripheral portion of the bottom surface and supporting the optical member and a second supporting portion supporting the light-mixing member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded cross sectional view showing a backlight assembly in accordance with a first embodiment of the invention.

FIG. 2 is a perspective view showing a container shown in FIG. 1.

FIG. 3 is a cross sectional view showing a backlight assembly in accordance with a second embodiment of the invention.

FIG. 4 is an enlarged cross sectional view illustrating a portion “A” shown in FIG. 3.

FIG. 5 is a cross sectional view illustrating a backlight assembly in accordance with a third embodiment of the invention.

FIG. 6 is an enlarged cross sectional view illustrating a portion “B” shown in FIG. 5.

FIG. 7 is a cross sectional view illustrating a backlight assembly in accordance with a fourth embodiment of the invention.

FIG. 8 is an enlarged cross sectional view showing a portion “C” in FIG. 7.

FIG. 9 is an exploded cross sectional view showing a display panel in accordance with a fifth embodiment of the invention.

### DESCRIPTION OF THE ILLUSTRATED EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout.

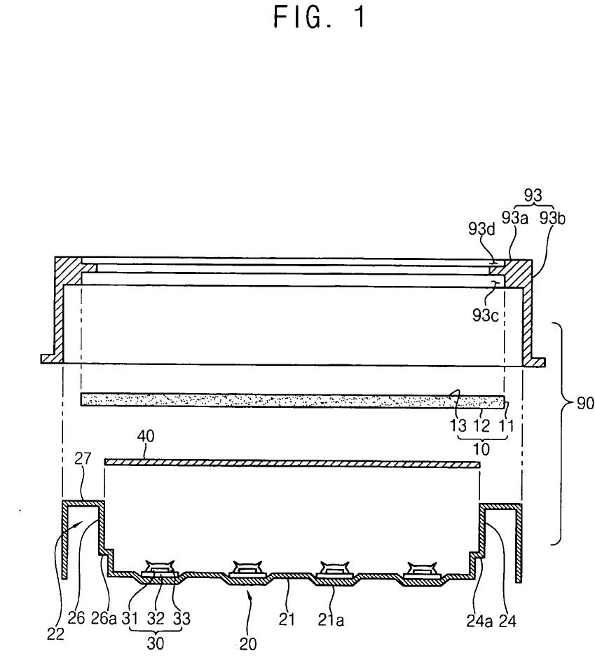

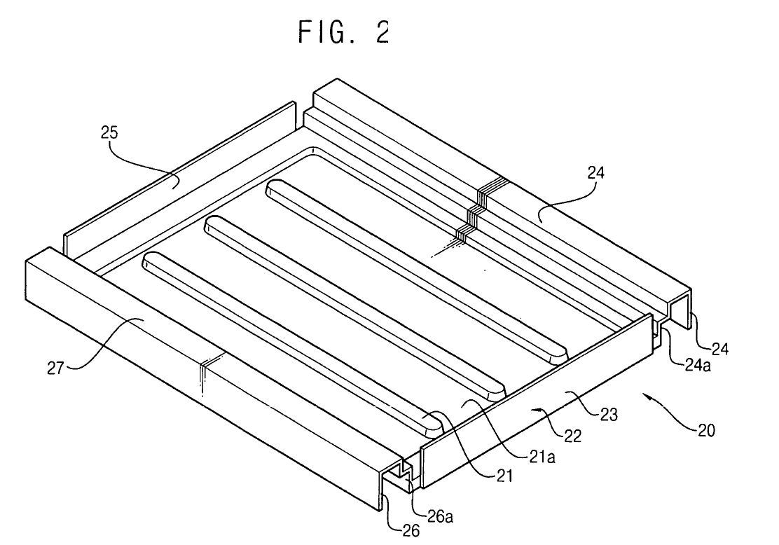

FIG. 1 is an exploded cross sectional view showing a backlight assembly in accordance with a first embodiment of the invention. FIG. 2 is a perspective view showing a container shown in FIG. 1.

Referring to FIG. 1 and FIG. 2, a backlight assembly 90 includes an optical member 10, a light source module 30, a light-mixing member 40, and a container 20.

The optical member 10 has a substantially plate-like shape. For example, the optical member 10 has a substantially rectangular parallelepipe-like shape. The optical member 10 includes side faces 1 1, a light incident face 12 and a light-exiting face 13 facing the light incident face 12. The optical member 10 may be a diffusing plate that diffuses a light.

The light source module 30 provides a color light to the optical member 10. The light source module 30 faces the light incident face 12 of the optical member 10. The light source module 30 includes a plurality of light sources 31, a substrate 32 and a lens 33.

The light sources 31 emit the color lights such as a red light, a green light and a blue light. Thus, the light source 31 may be a red LED, a green LED, a blue LED, a white LED, or a combination thereof.

The light sources 31 may be arranged in series on the substrate 32. Alternatively, the light sources 31 may be arranged in a zigzag formation on the substrate 32.

The light sources 31 and the lens 33 are arranged on the substrate 32. For example, the substrate 32 may be a substantially rectangular parallelepipe-like shape. A power supply (not shown) is electrically connected; e.g., coupled, with the light sources 31. A current from the power supply is transmitted to the light sources 31 through the substrate 32. The substrate 32 may be a printed circuit board.

A luminance of the color lights generated from the light sources 31 changes in accordance with a peripheral temperature of each of the light sources 31. For example, when the peripheral temperature of the light sources 31 increases, the luminance of the color lights generated from the light sources 31 decreases. To decrease the effect of the increase of the peripheral temperature, a metal having a high thermal conductivity may be coated on a surface of the substrate 32. The metal may include aluminum, aluminum alloy, etc.

The lens 33 is combined or attached with the light source 31. The light generated from each of the light source 31 is emitted through the lens 33. The lens 33 changes a path of the color light emitted from the light source 31. Thus, a volume of a region in which the color lights are converted into the white color may be reduced.

The light-mixing member 40 may be a substantially plate-like shape. The light-mixing member 40 is arranged between the optical member 10 and the light source module 30. The color lights such as the red light, green light and the blue light are mixed by the light-mixing member 40.

The container 20 includes a bottom surface 21 and a sidewall 22. The container 20 may be a metal plate.

The bottom surface 21 of the container 20 faces the light incident face 12 of the optical member 10. The bottom surface 21 may be a substantially rectangular parallelepipe-like shape corresponding to the light incident face 12.

A receiving space 21a in which the light source module 30 is received is arranged at a surface portion of the bottom surface 21 of the container 20. The receiving space 21a may be a recessed portion of the bottom surface 21.

When the light source module 30 is received in the receiving space 21a, a space between the light source module 30 and the light-mixing member 40 is decreased. As a result, a size and a volume of a display apparatus 95 may be reduced.

The receiving space 21a may be a substantially rectangular parallelepipe-like shape that is substantially the same as that of the light source module 30. The receiving space 21a is wider than the substrate 32.

The sidewall 22 of the container 20 includes first supports 27 and second supports 24a and 26a. The sidewall 22 is arranged at a peripheral portion of the bottom face 21 and is substantially perpendicular to a surface of the bottom face 21. The sidewall 22 includes a first side face 23, a second side face 24, a third side face 25 and a fourth side face 26. The first side face 23 faces the third side face 25 and the second side face 24 faces the fourth side face 26. Thus, the sidewall 22 defines the receiving space 21a between the optical member 10 and the bottom face 21.

The first supports 27 that support the optical member 10 are formed on the sidewall 22. The first supports 27 are formed on at least two faces arranged opposite to each other among the first side face 23, second side face 24, the third side face 25 and the fourth side face 26. For example, the first supports the 27 are formed on the second and fourth side faces 24 and 26. As shown in FIG. 1, portions of the second side face 24 and the fourth side face 26 are bent in a direction that is substantially perpendicular to the second side face 24 and the fourth side face 26 to form the first supports 27. When the first supports 27 are formed on the sidewall 22, a mold frame that supports the optical member 10 is no longer necessary.

The second supports 24a and 26a are arranged on the second side face 24 and the fourth side face 26. Alternatively, the second supports 24a and 26a may be arranged on the first side face 23 and the third side face 25.

The second supports 24a and 26a support the light-mixing member 40. Portions of the second side face 24 and the fourth side face 26 are bent to form the second supporting portions 24a and 26a. Alternatively, the second supporting portions 24a and 26a may include projections extending from inner faces of the second side face 24 and the fourth side face 26. Also, the second supports 24a and 26a may include members attached with the inner faces of the second side face 28 and the fourth side face 26.

Meanwhile, to attach the optical member 10 with the first supports 27, fixing members 93 are arranged on the first supports 27. The fixing members 93 include a first fixing portion 93a and a second fixing portion 93b. The first fixing portion 93a is arranged on the first supporting portion 27. The second fixing portion 93b extends from the first fixing portion 93a and is substantially parallel to the second side face 24 and the fourth side face 26.

A fixing groove 93c that secures the optical member 10 is provided at a surface of the first fixing portion 93a. The fixing groove 93c may be a step-like portion of the fixing member. A protrusion that fixes a display panel (not shown) is formed on the first fixing portion 93a.

Accordingly, the fixing member 93 secures the optical member 10 and the display panel. Alternatively, the fixing member 93 may further include a first member securing the optical member 10 and a second member securing the display panel.

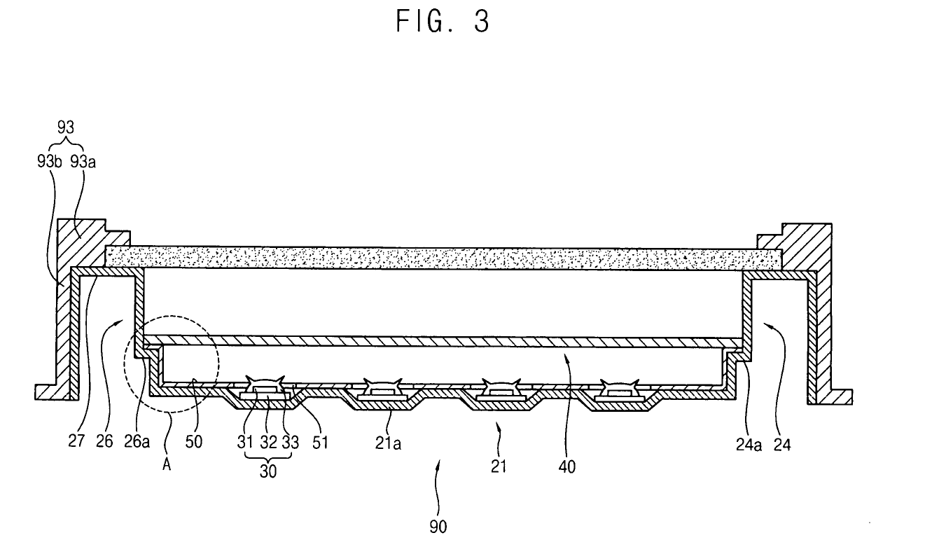

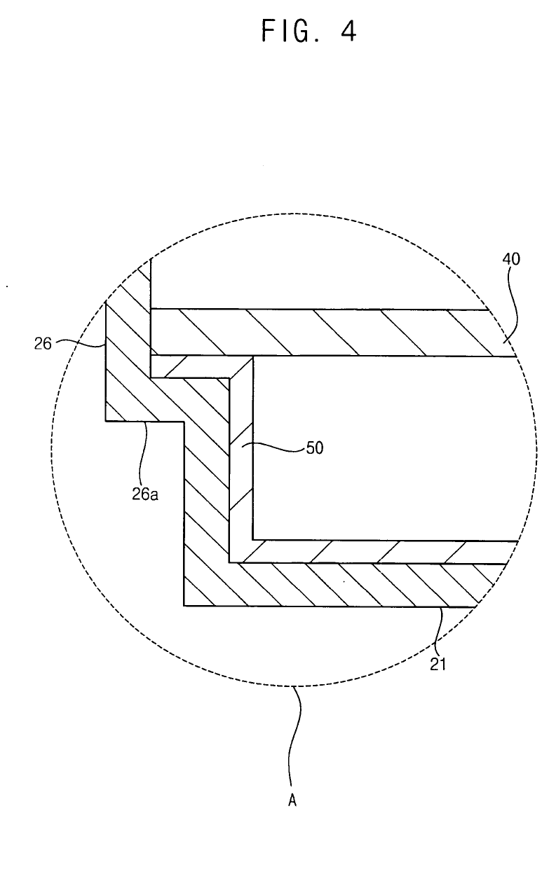

FIG. 3 is a cross sectional view illustrating a backlight assembly according to a second embodiment of the invention. FIG. 4 is an enlarged cross sectional view illustrating a portion “A” shown in FIG. 3.

A backlight assembly includes elements substantially identical to those described above for the first embodiment, except a light-reflecting member. Thus, same reference numerals are used to refer to the same elements and any further illustrations of the same elements are omitted as necessary.

Referring to FIG. 3 and FIG. 4, a backlight assembly 90 further includes the light-reflecting member 50. The light-reflecting member 50 is arranged on the bottom surface 21 of the container 20 facing the light mixing member 40. The light-reflecting member 50 has an opening 51 through which the light irradiated from the lens 33 of the light source module 30 in the receiving space 21a passes.

The light-reflecting member 50 reflects a light reflected from the light-mixing member 40 toward the light-mixing member 40. The light is mixed in a space between the light-mixing member 40 and the light-reflecting member 50. The light-reflecting member 50 has a higher photoreflectance than either of the container 20 of the light source module 30.

The light-reflecting member 50 has a peripheral portion extending along the second side face 24 and the fourth side face 26 of the container 20. The peripheral portion of the light-reflecting member 50 does not extend beyond the second supports 24a and 26a. Thus, the peripheral portion of the light-reflecting member 50 is arranged between the second supports 24a and 26a and the light-mixing member 40. Alternatively, the peripheral portion of the light-reflecting member 50 may extend beyond the second supports 24a and 26a to the light incident face 12 of the optical member 10 along inner faces of the sidewall 22.

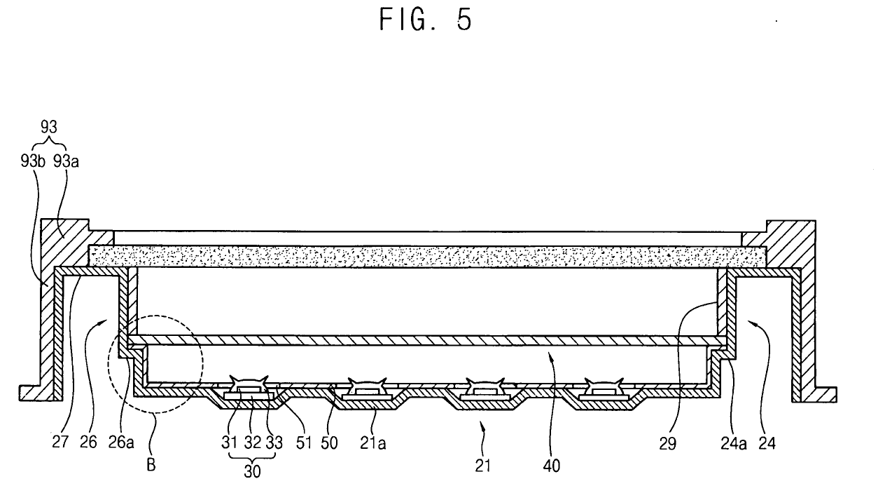

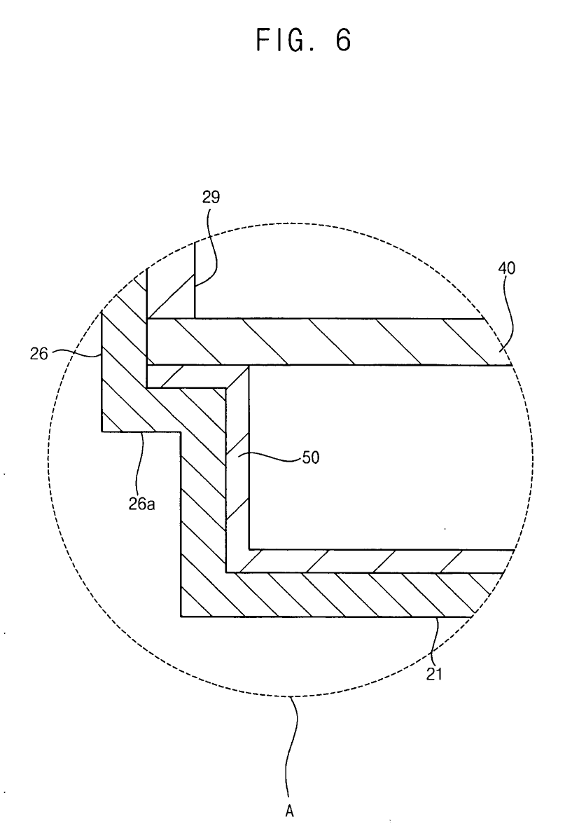

FIG. 5 is a cross sectional view showing a backlight assembly according to another embodiment of the invention. FIG. 6 is an enlarged cross sectional view illustrating a portion “B” shown in FIG. 5.

A backlight assembly includes elements substantially identical to those elements described in the second embodiment, except a light-reflecting sheet. Thus, same reference numerals are used to refer to same elements and any further illustrations of the same elements are omitted as necessary.

Referring to FIG. 5 and FIG. 6, the light-reflecting sheet 29 is attached with portions of the sidewall 22 corresponding to an upper portion of the second supports 24a and 26a. The light-reflecting sheet 29 has a higher photoreflectance than the light-reflecting member 50 shown in the second embodiment.

The light-reflecting sheet 29 reflects a light directed to the sidewall 22 toward the light-mixing member 40 to reduce light loss and improve.

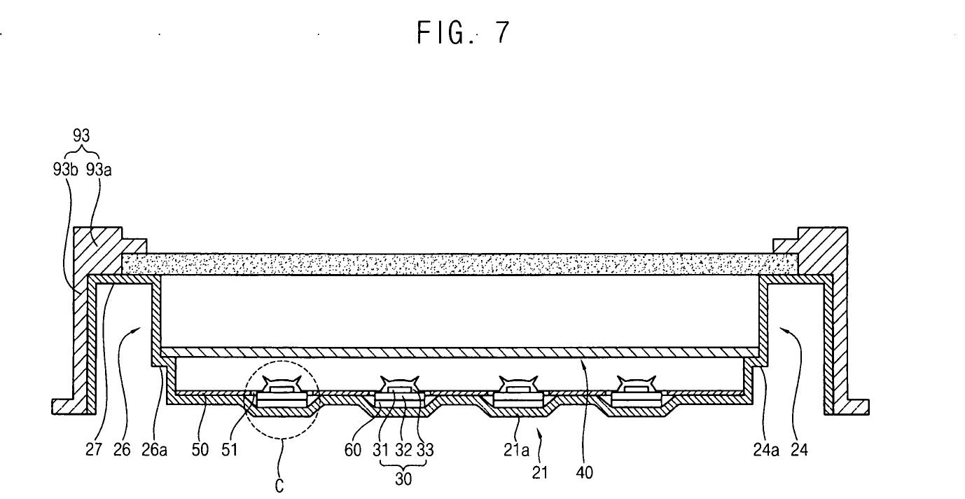

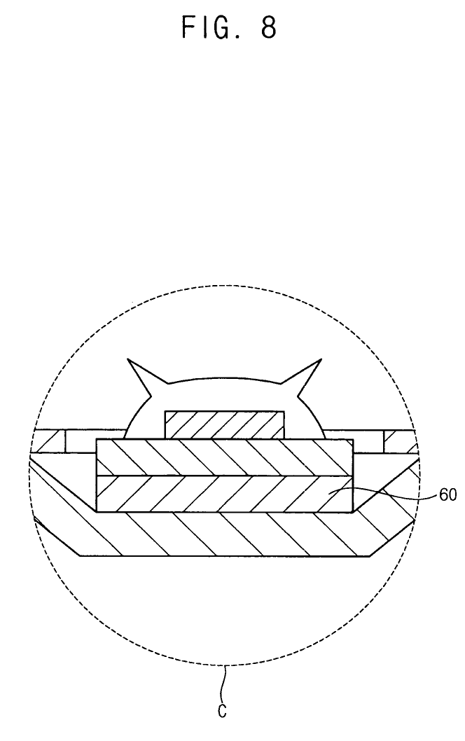

FIG. 7 is a cross sectional view showing a backlight assembly according to another embodiment of the invention. FIG. 8 is an enlarged cross sectional view illustrating a portion “C” shown in FIG. 7.

A backlight assembly includes elements substantially identical to those described above in the second embodiment except for a heat-dissipating member. Thus, same reference numerals are used to refer to same elements and any further illustrations of the same elements are omitted as necessary.

Referring to FIG. 7 and FIG. 8, the heat-dissipating member 60 is arranged between the bottom face 21 of the container 20 and the substrate 32 of the light source module 30. The heat-dissipating member 60 may be a thin film that is about 0.02 inches to about 0.06 inches thick. The heat-dissipating member 60 may have a thermal conductivity of about 100 W/mK to about 500 W/mK.

The beat-dissipating member 60 has a smaller volume and size than a conventional metal cooling fin or a conventional cooling pipe. The heat-dissipating member 60 has a thermal conductivity that is several to hundreds times greater than that of the metal cooling fin or the cooling pipe. The heat-dissipating member 60 may be a Spreader Shield (product name produced by Graftech international Co., Ltd. in U.S.).

According to such embodiment, a size, a volume and a weight of the container 20 may be significantly reduced by arranging to the heat-dissipating member 60 between the bottom face 21 of the container 20 and the light source module 30.

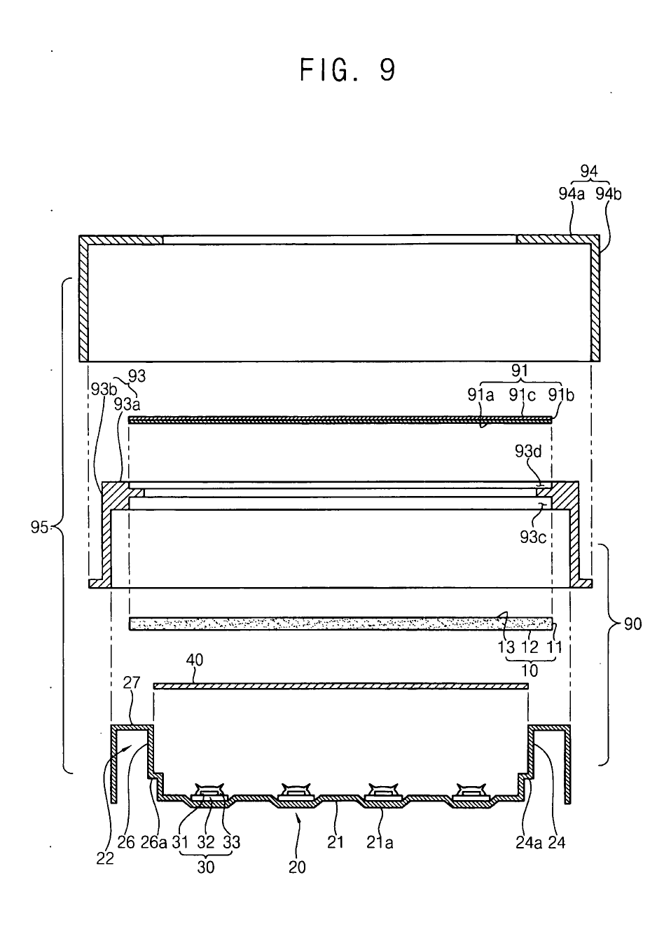

FIG. 9 is an exploded cross sectional view illustrating a display panel in accordance with another embodiment of the invention.

Referring to FIG. 9, a display apparatus 95 includes a backlight assembly 90, a display panel 91, and a chassis 94.

The backlight assembly 90 includes an optical member 10, a light source module 30, a light-mixing member 40, and a container 20.

The optical member 10 may be a substantially plate-like shape. The optical member 10 may have a substantially rectangular parallelepipe-like shape. The optical member 10 includes side faces 1, a light incident face 12, and a light-exiting face 13 facing the light incident face 12. The optical member 10 may be a diffusing plate that diffuses a light.

The light source module 30 transmits a color light to the optical member 10. The light source module 30 faces the light incident face 12 of the optical member 10. The light source module 30 includes a plurality of light sources 31, a substrate 32, and a lens 33.

The light sources 31 emit the color lights such as a red light, a green light and a blue light. For example, the light sources 31 may include a red LED, a green LED, a blue LED, a white LED, and/or a combination thereof.

The light sources 31 may be arranged in series on the substrate 32. Alternatively, the light sources 31 may be arranged in a zigzag formation on the substrate 32.

The light sources 31 and the lens 33 are received or arranged on the substrate 32. For example, the substrate 32 may be a substantially rectangular parallelepipe-like shape. A power supply (not shown) is electrically connected; e.g., coupled, with the light sources 31. A current from the power supply is provided to the light sources 31 through the substrate 32. The substrate 32 may be a printed circuit board.

A luminance of the color lights generated from the light sources 31 changes according to a peripheral or external temperature of each of the light sources 31. For example, when the peripheral temperature of the light sources 31 increases, the luminance of the color lights generated from the light sources 31 decreases. To reduce the increase of the peripheral temperature, a metal having a high thermal conductivity may be coated or applied on a surface of the substrate 32. The metal may include aluminum, aluminum alloy, etc.

The lens 33 is combined or attached with the light sources 31. The light generated from each of the light sources 31 is emitted through the lens 33. The lens 33 changes angles of the color lights emitted from the light sources 31. Accordingly, a volume of a region where the color lights are converted into the white color may be reduced.

The light-mixing member 40 has a substantially plate-like shape. The light-mixing member 40 is arranged between the optical member 10 and the light source module 30. The color lights such as the red light, green light and the blue light are mixed in an area below the light-mixing member 40.

The container 20 includes a bottom surface 21 and a sidewall 22. The container 20 may be a metal plate.

The bottom surface 21 of the container 20 faces the light incident face 12 of the optical member 10. The bottom surface 21 has a substantially rectangular parallelepipe-like shape corresponding to that of the light incident face 12.

A receiving space 21a where the light source module 30 is received is formed at a surface portion of the bottom surface 21 of the container 20. The receiving space 21a may include a recess.

When the light source module 30 is received in the receiving space 21 a, space between the light source module 30 and the light-mixing member 40 is decreased. As a result, a size and a volume of a display apparatus 95 may be reduced.

The receiving space 21a has a shape that is substantially identical to that of the light source module 30. The receiving space 21a has a larger area than the substrate 32.

The sidewall 22 of the container 20 includes first supports 27 and second supports 24a and 26a. The sidewall 22 is arranged on a peripheral portion of the bottom face 21 and is substantially perpendicular to a surface of the bottom face 21. Also, the sidewall 22 includes a first side face 23, a second side face 24, a third side face 25 and a fourth face 26. The first side face 23 faces the third side face 25 and the second side face 24 faces the fourth side face 26. Thus, the sidewall 22 defines or forms the receiving space 21a between the optical member 10 and the bottom face 21.

The first supporting portions 27 that support the optical member 10 are arranged on the sidewall 22. The first supporting portions 27 are arranged on at least two faces that are opposite to each other among the first side face 23, the second side face 24, the third side face 25 and the fourth side face 26. For example, the first supporting portions 27 are arranged on the second side face 24 and the fourth side face 26. Portions of the second side face 24 and the fourth side face 26 are bent in a direction substantially perpendicular to the second side face 24 and the fourth side face 26 to form the first supporting portions 27. When the first supporting portions 27 are arranged on the sidewall 22, a mold frame that supports the optical member 10 is not needed.

The second supporting portions 24a and 26a are arranged on the second side face 24 and the fourth side face 26. Alternatively, the second supporting portions 24a and 26a may be formed on the first side face 23 and the third side face 25.

The second supporting portions 24a and 26a support the light-mixing member 40. Portions of the second side face 24 and the fourth side face 26 are bent to form the second supporting portions 24a and 26a. Alternatively, the second supporting portions 24a and 26a may include projections protruded from inner faces of the second side face 24 and the fourth side face 26. The second supporting portions 24a and 26a may further include members attached with the inner faces of the second side face 28 and the fourth side face 26.

To attach the optical member 10 on the first supporting portions 27, fixing members 93 are arranged on the first supporting portions 27. The fixing members 93 include a first fixing portion 93a and a second fixing portion 93b. The first fixing portion 93a is arranged on the first supporting portions 27. The second fixing portion 93b extends from the first fixing portion 93a in a direction that is substantially parallel to the second side face 24 and the fourth side face 26.

A fixing groove 93c that secures the optical member 10 provided at a surface portion of the first fixing portion 93a. A protrusion that fixes a display panel 91 is formed on the first fixing portion 93a.

According to the embodiment, the fixing member 93 secures the optical member 10 and the display panel 91. Alternatively, the fixing member 93 may include a first member securing the optical member 10 and a second member fixing the display panel 91.

The display panel 91 includes a TFT substrate 91 a having a plurality of pixel electrodes and a plurality of TFTs, a color filter substrate 91c having a common electrode and a color filter, and a liquid crystal 91b arranged between the TFT substrate 91a and the color filter substrate 91c. The display panel 91 is arranged on a protruded portion 93d arranged on the first fixing portion 93a of the fixing member 93.

The chassis 94 secures the display panel 91 with the fixing member 93. The chassis 94 includes a first chassis portion 94a and a second chassis portion 94b. The first chassis portion 94a compresses a peripheral portion of the display panel 91. The second chassis portion 94b extends from the first chassis portion 94a along the second fixing portion 93b. The second chassis portion 94b may be combined with the second fixing portion 93b of the fixing member 93 using a hook.

According to the above described embodiments of the invention, the backlight assembly may have a compact size and may have an improved display quality without increasing the volume and the weight of the display apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A backlight assembly, comprising:
an optical member;
a light source module providing color light to the optical member;
a light-mixing member arranged between the optical member and the light source module; and
a container with a bottom surface that has a receiving space to receive the light source module, and a sidewall having a first supporting portion extending from a peripheral portion of the bottom surface to support the optical member and a second supporting portion to support the light-mixing member.

2. The backlight assembly of claim 1, further comprising:
a light-reflecting member arranged on the bottom surface of the container, the light-reflecting member extending along the sidewall to the second supporting portion.

3. The backlight assembly of claim 1, wherein the first supporting portion and the second supporting portion are formed on at least two surfaces of the sidewall.

4. The backlight assembly of claim 3, wherein the first supporting portion is formed on two opposite surfaces of the sidewall.

5. The backlight assembly of claim 1, further comprising:
a heat-dissipating member arranged between the bottom surface and the light source module, the heat-dissipating member having a thin film.

6. The backlight assembly of claim 5, wherein the heat-dissipating member has a thermal conductivity of about 100 W/mK to about 500 W/mK.

7. The backlight assembly of claim 5, wherein the heat-dissipating member is about 0.02 inches thick to about 0.06 inches thick.

8. The backlight assembly of claim 1, further comprising:
a fixing member securing the optical member.

9. The backlight assembly of claim 8, wherein the fixing member comprises:
a first fixing groove securing the optical member; and
a second fixing groove positioned opposite to the first fixing groove.

10. The backlight assembly of claim 1, wherein the light source module comprises:
a light source emitting the color lights;
a substrate providing power to the light source; and
a lens altering a path of the color lights emitting from the light source.

11. The backlight assembly of claim 10, wherein the light source comprises at least one LED selected from the group of a red LED, a green LED and a blue LED.

12. The backlight assembly of claim 1, wherein the optical member comprises:
a diffusing plate to diffuse the color lights.

13. The backlight assembly of claim 1, further comprising:
a light-reflecting member arranged on the bottom surface.

14. The backlight assembly of claim 1, further comprising:
a light-reflecting member formed on an inner surface of the container.

15. The backlight assembly of claim 14, wherein the light-reflecting member is arranged between the first supporting portion and the second supporting portion.

16. The display apparatus of claim 1, further comprising:
a panel-guiding member attached with the first supporting portion;
a display panel arranged on the panel guiding member, the display panel positioned opposite to the optical member; and
a chassis securing a peripheral portion of the display panel, the chassis being secured to the container.
